(19) United States
(12) Patent Application Publication
(10) Pub. No.: US 2026/0338222 A1
(43) Pub. Date: Oct. 29, 2026

(54) TUBE ASSEMBLY FOR A FLEXIBLE SHAFT AND FLEXIBLE SHAFT

(71) Applicant: Wei HUANG, Shenzhen (CN)

(72) Inventors: Shenwang CHEN, Shenzhen (CN); Wei HUANG, Shenzhen (CN); Zhigang LIU, Shenzhen (CN)

(73) Assignee: Wei HUANG, Shenzhen (CN)

(21) Appl. No.: 19/338,237

(22) Filed: Sep. 24, 2025

(30) Foreign Application Priority Data
Apr. 29, 2025 (CN) 202520843169.7

(51) Int. Cl. F16C 1/26; F16C 1/06

(52) U.S. Cl. CPC F16C 1/26; F16C 1/06

(57) ABSTRACT

A tube assembly for a flexible shaft includes a first tube member, wherein connecting members are provided at both axial ends of the first tube member; a second tube is sleeved on an outer peripheral wall of at least one of the two connecting members; an inner peripheral wall of the second tube member is provided with a first groove extending circumferentially, the outer peripheral wall of the connecting member is provided with a first protrusion extending circumferentially and engaging with the first groove, and/or the inner peripheral wall of the second tube member is provided with a second protrusion extending circumferentially, the outer peripheral wall of the connecting member is provided with a second groove extending circumferentially and engaging with the second protrusion.

### CROSS-REFERENCE TO RELATED APPLICATIONS

This application claims priority to Chinese Patent Application No. 202520843169.7, filed on Apr. 29, 2025, the content of which is incorporated herein by reference in its entirety.

### TECHNICAL FIELD

The present disclosure relates to the field of flexible shaft technology, and more particularly to a tube assembly for a flexible shaft and a flexible shaft.

### BACKGROUND

In daily life, flexible shafts are common transmission tools. A flexible shaft typically includes a tube assembly and a drive shaft extending through the tube assembly. The tube assembly usually includes a metal hose, a metal housing, and a connecting member that connects the metal hose and the metal housing.

In the related art, the metal housing and the connecting member are usually joined by a press-riveting technique. Such a connection method is prone to loosening between the metal housing and the connecting member, and may even result in the metal housing detaching from the connecting member.

### SUMMARY

An embodiment of the present disclosure provides a tube assembly for a flexible shaft, configured to solve the problem in the prior art where the second tube member and the connecting member are prone to loosening.

The tube assembly for a flexible shaft according to an embodiment of the present disclosure includes:
a first tube member, wherein connecting members are provided at both axial ends of the first tube member;
a second tube is sleeved on an outer peripheral wall of at least one of the two connecting members;
an inner peripheral wall of the second tube member is provided with a first groove extending circumferentially, the outer peripheral wall of the connecting member is provided with a first protrusion extending circumferentially and engaging with the first groove, and/or
the inner peripheral wall of the second tube member is provided with a second protrusion extending circumferentially, the outer peripheral wall of the connecting member is provided with a second groove extending circumferentially and engaging with the second protrusion.

In an embodiment of the present disclosure, the tube assembly for a flexible shaft achieves engagement and fixation between the second tube member and the connecting member by providing a first protrusion and a first groove, or a second protrusion and a second groove, or both the first protrusion and first groove and the second protrusion or second groove. Through the cooperation of these protrusions and grooves, the second tube member can be fixed to the connecting member. Compared with the connection method in the prior art using riveting, this configuration can prevent loosening between the second tube member and the connecting member.

Therefore, the tube assembly for a flexible shaft according to the embodiment of the present disclosure can prevent loosening between the second tube member and the connecting member.

In some embodiments, the first groove is singular, and the first protrusion is singular; or the first grooves are plural, and the plurality of first grooves are spaced apart axially along the second tube member; and the first protrusions are plural, and the plurality of first protrusion are spaced apart axially along the connecting member.

In some embodiments, the second groove is singular, and the second protrusion is singular; or
the second grooves are plural, and the plurality of second grooves are spaced apart axially along the connecting member; and the second protrusions are plural, and the plurality of second protrusions are spaced apart axially along the second tube member.

In some embodiments, the inner peripheral wall of the second tube member is provided with a third groove extending axially, the outer peripheral wall of the connecting member is provided with a third protrusion extending axially and engaging with the third groove, and/or
the inner peripheral wall of the second tube member is provided with a fourth protrusion extending axially, the outer peripheral wall of the connecting member is provided with a fourth groove extending axially and engaging with the fourth protrusion.

In some embodiments, the third groove is singular, and the third protrusion is singular; or
the third grooves are plural, and the plurality of third grooves are spaced apart circumferentially along the inner peripheral wall of the second tube member; and the third protrusions are plural, and the plurality of third protrusions are spaced apart circumferentially along the outer peripheral wall of the connecting member.

In some embodiments, the fourth groove is singular, and the fourth protrusion is singular; or
the fourth grooves are plural, and the plurality of fourth grooves are spaced apart circumferentially along the outer peripheral wall of the connecting member; and the fourth protrusions are plural, and the plurality of fourth protrusions are spaced apart circumferentially along the inner peripheral wall of the second tube member.

In some embodiments, a hose is sleeved on an outer wall of the first tube member.

In some embodiments, knurling is provided on an outer wall of the second tube member.

The present disclosure also provides a flexible shaft.

In an embodiment of the present disclosure, the flexible shaft includes:
the tube assembly for a flexible shaft as described in the foregoing embodiments; and a core shaft;
the core shaft is provided in the first tube member, two ends of the core shaft pass through the connecting members provided at both ends of the first tube member and extend into the second tube member;
an end of the core shaft is connected to a first drive connecting member, an end of the first drive connecting member away from the core shaft extends out of the corresponding second tube member; and
another end of the core shaft is connected to a second drive connecting member, an end of the second drive connecting member away from the core shaft extends out of the corresponding second tube member.

The flexible shaft according to the embodiment of the present disclosure is capable of transmitting motion between two ends that are not on the same axis. For example, the first drive connecting member can be connected to a screwdriver, and the second drive connecting member can be connected to a screw. The screwdriver can drive the core shaft to rotate, which in turn drives the screw to rotate. This allows screws located in positions where it is inconvenient to place a screwdriver to be assembled or disassembled, thereby improving work efficiency.

In an embodiment of the present disclosure, the flexible shaft further includes a spring; the spring is sleeved on the outer side of the core shaft and is disposed between the connecting member and the first drive connecting member.

### BRIEF DESCRIPTION OF THE DRAWINGS

In order to more clearly illustrate the technical solutions of the embodiments of the present disclosure, the drawings used in the description of the embodiments of the present disclosure are briefly introduced below. It is apparent that the drawings described below are only some embodiments of the present disclosure. Those skilled in the art can, without inventive effort, derive other drawings based on these drawings.

FIG. 1 is a schematic view of a tube assembly for a flexible shaft according to an embodiment of the present disclosure.

FIG. 2 is an enlarged view of part A in FIG. 1.

FIG. 3 is a sectional view of the connection between the second tube member and the connecting member according to an embodiment of the present disclosure.

FIG. 4 is a sectional view of the connection between the second tube member and the connecting member according to another embodiment of the present disclosure.

### REFERENCE SIGNS IN THE DRAWINGS ARE AS FOLLOWS

100. Tube assembly;
200. Flexible shaft;
1. First tube member;
2. Connecting member;
3. First groove;
4. First protrusion;
5. Second groove;
6. Second protrusion;
7. Third groove;
8. Fourth protrusion;
9. Fourth groove;
10. Core shaft;
11. First drive connecting member;
12. Second drive connecting member;
13. Spring;
14. Hose;
15. Second tube member;
16. Third protrusion.

### DETAILED DESCRIPTION OF THE EMBODIMENTS

In order to make the technical problem, technical solution, and beneficial effects of the present disclosure clearer, the present disclosure is further described in detail below in conjunction with the drawings and embodiments. It should be understood that the specific embodiments described herein are only intended to illustrate the present disclosure and are not intended to limit the present disclosure.

In the description of the present disclosure, it should be understood that the terms indicating orientation or positional relationships, such as “longitudinal,” “radial,” “length,” “width,” “thickness,” “upper,” “lower,” “front,” “rear,” “left,” “right,” “vertical,” “horizontal,” “top,” “bottom,” “inner,” and “outer,” are based on the orientation or positional relationships shown in the drawings. They are used merely for the convenience of describing the present disclosure and for simplifying the description, and are not intended to indicate or imply that the device or component must have a particular orientation, or be constructed or operated in a particular orientation. Therefore, these terms should not be construed as limiting the present disclosure.

Unless otherwise specified, the term “plurality” in the description of the present disclosure means two or more.

In the description of the present disclosure, it should be noted that, unless otherwise explicitly specified or limited, the terms “mounted,” “connected,” and “coupled” should be understood in a broad sense. For example, they may refer to a fixed connection or a detachable connection, or an integral connection; they may refer to a mechanical connection or an electrical connection; they may refer to a direct connection or an indirect connection through an intermediate medium, or to overmolding within two components. Those skilled in the art can understand the specific meaning of these terms in the context of the present disclosure according to the particular circumstances.

It should also be noted that, in the present application, the first tube member 1 corresponds to the first tube member 1 in the background art, and the second tube member 15 corresponds to the second tube member 15 in the background art. They are not necessarily required to be made of metal, and this should not be construed as limiting the present disclosure.

To solve the problem in the prior art where loosening easily occurs between the second tube member 15 and the connecting member 2 of the tube assembly of the flexible shaft 200, the present disclosure provides a tube assembly for a flexible shaft 100.

The tube assembly for a flexible shaft 100 according to an embodiment of the present disclosure includes a first tube member 1, wherein connecting members 2 are provided at both axial ends of the first tube member 1. Second tube members 15 are sleeved on the outer peripheral walls of the two connecting members 2. The inner peripheral wall of the second tube member 15 is provided with a first groove 3 extending circumferentially, and the outer peripheral wall of the connecting member 2 is provided with a first protrusion 4 extending circumferentially and engaging with the first groove 3.

And/or, the inner peripheral wall of the second tube member 15 is provided with a second protrusion 6 extending circumferentially, and the outer peripheral wall of the connecting member 2 is provided with a second groove 5 extending circumferentially and engaging with the second protrusion 6.

The tube assembly for a flexible shaft 100 according to an embodiment of the present disclosure achieves engagement and fixation between the second tube member 15 and the connecting member 2 by providing a first protrusion 4 and a first groove 3, or a second protrusion 6 and a second groove 5, or both the first protrusion 4 and first groove 3 and the second protrusion 6 or second groove 5. Through the cooperation of these protrusions and grooves, the second tube member 15 can be fixed to the connecting member 2. Compared with the connection method in the prior art using riveting, this configuration can prevent loosening between the second tube member 15 and the connecting member 2.

Therefore, the tube assembly for a flexible shaft 100 according to an embodiment of the present disclosure can prevent loosening between the second tube member 15 and the connecting member 2.

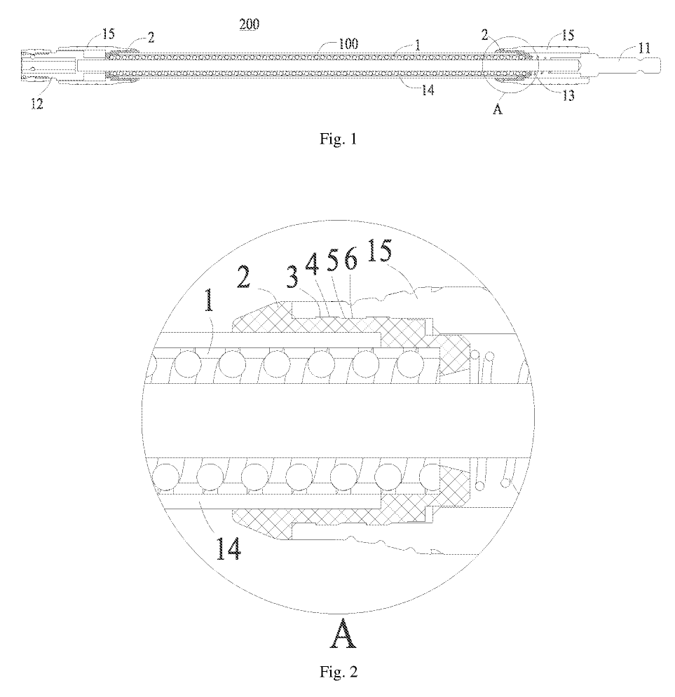

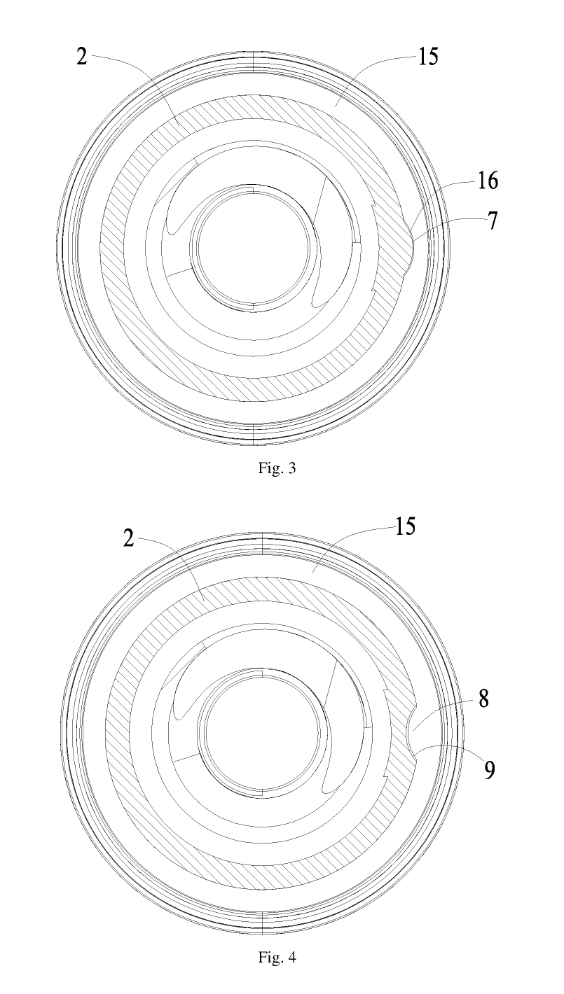

The tube assembly for a flexible shaft 100 according to an embodiment of the present disclosure is described below with reference to FIGS. 1-4.

As shown in FIG. 1, the tube assembly for a flexible shaft 100 according to an embodiment of the present disclosure includes a first tube member 1 and second tube members 15, wherein connecting members 2 are provided at both axial ends of the first tube member 1. Second tube members 15 are sleeved on the outer peripheral walls of the two connecting members 2. That is, the connecting members 2 serve to connect the second tube members 15 to the first tube member 1.

In practical applications, the connecting member 2 can be connected to the first tube member 1 by being inserted into the interior of the first tube member 1, or it can be sleeved on the outside of the first tube member 1 to connect to the first tube member 1. The terms “inserted” and “sleeved” here only describe the positional relationship between the connecting member 2 and the first tube member 1 and do not limit the manufacturing or assembly process of the connecting member 2 and the first tube member 1.

For example, the connecting member 2 may be an injection-molded part, where the two ends of the first tube member 1 are placed in the injection mold of the connecting member 2, and the connecting member 2 can be directly injection-molded onto the two ends of the first tube member 1. This can improve the connection strength between the first tube member 1 and the connecting member 2.

The inner peripheral wall of the second tube member 15 is provided with a first groove 3 extending circumferentially, and the outer peripheral wall of the connecting member 2 is provided with a first protrusion 4 extending circumferentially and engaging with the first groove 3.

And/or, the inner peripheral wall of the second tube member 15 is provided with a second protrusion 6 extending circumferentially, and the outer peripheral wall of the connecting member 2 is provided with a second groove 5 extending circumferentially and engaging with the second protrusion 6.

For example, the inner peripheral wall of the second tube member 15 is provided with a first groove 3 extending circumferentially, and the outer peripheral wall of the corresponding connecting member 2 is provided with a first protrusion 4 extending circumferentially and engaging with the first groove 3.

For example, the inner peripheral wall of the second tube member 15 is provided with a second protrusion 6 extending circumferentially, and the outer peripheral wall of the connecting member 2 is provided with a second groove 5 extending circumferentially and engaging with the second protrusion 6.

For example, the inner peripheral wall of the second tube member 15 is provided with a first groove 3 extending circumferentially, and the outer peripheral wall of the connecting member 2 is provided with a first protrusion 4 extending circumferentially and engaging with the first groove 3. The inner peripheral wall of the second tube member 15 is further provided with a second protrusion 6 extending circumferentially, and the outer peripheral wall of the connecting member 2 is provided with a second groove 5 extending circumferentially and engaging with the second protrusion 6.

By forming the connecting member 2 as an injection-molded component, when assembling the second tube member 15 to the connecting member 2, one only needs to fix the first tube member 1 together with the connecting member 2, and then press-fit the second tube member 15 onto the connecting member 2.

For example, a hand press machine may be used to install the second tube member 15 onto the connecting member 2. First, a clamping tool is used to fix the connecting member 2 and/or the first tube member 1 on the fixture. After aligning the second tube member 15 with the connecting member 2, the lower pressing head of the hand press machine is actuated to apply a downward pressure to the second tube member 15, thereby assembling the second tube member 15 onto the connecting member 2.

The tube assembly for a flexible shaft 100 according to an embodiment of the present disclosure achieves engagement and fixation between the second tube member 15 and the connecting member 2 by providing a first protrusion 4 and a first groove 3, or a second protrusion 6 and a second groove 5, or both the first protrusion 4 and first groove 3 and the second protrusion 6 or second groove 5. Through the cooperation of these protrusions and grooves, the second tube member 15 can be fixed to the connecting member 2. Compared with the connection method in the prior art using riveting, this configuration can prevent loosening between the second tube member 15 and the connecting member 2.

In some embodiments, the first groove 3 is singular, and the first protrusion 4 is singular.

By configuring both the first groove 3 and the first protrusion 4 as singular, it is possible to reduce the machining difficulty of the connecting member 2 and the second tube member 15 while meeting the connection requirements between the connecting member 2 and the second tube member 15.

In some embodiments, the first grooves 3 are plural, and the plurality of first grooves 3 are spaced apart axially along the second tube member 15. The first protrusions 4 are plural, and the plurality of first protrusions 4 are spaced apart axially along the connecting member 2.

By configuring the first grooves 3 and the first protrusions 4 as plural, the connection strength between the connecting member 2 and the second tube member 15 can be further improved. In practical applications, this can be selected based on connection requirements.

In some embodiments, the second groove 5 is singular, and the second protrusion 6 is singular.

By configuring both the second groove 5 and the second protrusion 6 as singular, it is possible to reduce the machining difficulty of the connecting member 2 and the second tube member 15 while meeting the connection requirements between the connecting member 2 and the second tube member 15.

In some embodiments, the second grooves 5 are plural, and the plurality of second grooves 5 are spaced apart axially along the connecting member 2; the second protrusion 6 are plural, and the plurality of second protrusion 6 are spaced apart axially along the second tube member 15.

By configuring the second grooves 5 and the second protrusions 6 as plural, the connection strength between the connecting member 2 and the second tube member 15 can be further improved. In practical applications, this can be selected based on connection requirements.

In some embodiments, the inner peripheral wall of the second tube member 15 is provided with a third groove 7 extending axially, and the outer peripheral wall of the connecting member 2 is provided with a third protrusion 16 extending axially and engaging with the third groove 7.

And/or, the inner peripheral wall of the second tube member 15 is provided with a fourth protrusion 8 extending axially, and the outer peripheral wall of the connecting member 2 is provided with a fourth groove 9 extending axially and engaging with the fourth protrusion 8.

For example, the inner peripheral wall of the second tube member 15 is provided with a third groove 7 extending axially, and the outer peripheral wall of the connecting member 2 is provided with a third protrusion 16 extending axially and engaging with the third groove 7.

For example, the inner peripheral wall of the second tube member 15 is provided with a fourth protrusion 8 extending axially, and the outer peripheral wall of the connecting member 2 is provided with a fourth groove 9 extending axially and engaging with the fourth protrusion 8.

For example, the inner peripheral wall of the second tube member 15 is provided with a third groove 7 extending axially, and the outer peripheral wall of the connecting member 2 is provided with a third protrusion 16 extending axially and engaging with the third groove 7. The inner peripheral wall of the second tube member 15 is further provided with a fourth protrusion 8 extending axially, and the outer peripheral wall of the connecting member 2 is provided with a fourth groove 9 extending axially and engaging with the fourth protrusion 8.

The tube assembly for a flexible shaft 100 according to an embodiment of the present disclosure further achieves engagement and fixation between the second tube member 15 and the connecting member 2 by providing a third protrusion 16 and a third groove 7, or a fourth protrusion 8 and a fourth groove 9, or by providing both the third protrusion 16 and the third groove 7 and the fourth protrusion 8 or the fourth groove 9. Through the cooperation of the above protrusions and grooves, the second tube member 15 and the connecting member 2 can be further fixed in a snap-fit manner, that is, the second tube member 15 and the connecting member 2 can be snap-fitted and fixed in both the axial direction and the circumferential direction. Compared with the connection method using riveting in the prior art, this configuration can further prevent loosening between the second tube member 15 and the connecting member 2.

In some embodiments, the third groove 7 is singular, and the third protrusion 16 is singular.

By configuring both the third groove 7 and the third protrusion 16 as singular, it is possible to reduce the machining difficulty of the connecting member 2 and the second tube member 15 while meeting the connection requirements between the connecting member 2 and the second tube member 15.

In some embodiments, the third grooves 7 are plural, and the plurality of third grooves 7 are spaced apart circumferentially along the inner peripheral wall of the second tube member 15; the third protrusions 16 are plural, and the plurality of third protrusions 16 are spaced apart circumferentially along the outer peripheral wall of the connecting member 2.

By configuring the third grooves 7 and the third protrusions 16 as plural, the connection strength between the connecting member 2 and the second tube member 15 can be further improved. In practical applications, this can be selected based on connection requirements.

In some embodiments, the fourth groove 9 is singular, and the fourth protrusion 8 is singular.

By configuring both the fourth groove 9 and the fourth protrusion 8 as singular, it is possible to reduce the machining difficulty of the connecting member 2 and the second tube member 15 while meeting the connection requirements between the connecting member 2 and the second tube member 15.

In some embodiments, the fourth grooves 9 are plural, and the plurality of fourth grooves 9 are spaced apart circumferentially along the outer peripheral wall of the connecting member 2; the fourth protrusions 8 are plural, and the plurality of fourth protrusions 8 are spaced apart circumferentially along the inner peripheral wall of the second tube member 15.

By configuring the fourth grooves 9 and the fourth protrusions 8 as plural, the connection strength between the connecting member 2 and the second tube member 15 can be further improved. In practical applications, this can be selected based on connection requirements.

In some embodiments, a hose 14 is sleeved on the outer wall of the first tube member 1.

By sleeving the hose 14 on the outer wall of the first tube member 1, the water- and oil-resistance of the tube assembly 100 for a flexible shaft according to the embodiment of the present disclosure can be improved.

Furthermore, the two ends of the hose 14 can be connected to the connecting members 2. As shown in the Figures, the two ends of the hose 14 can extend into the connecting members 2, which can further enhance the water- and oil-resistance of the tube assembly 100 for a flexible shaft according to the present disclosure.

It should be understood that the hose 14 can be co-injected with the connecting members 2 onto the first tube member 1. That is, the first tube member 1 can be placed in an injection mold, allowing the hose 14 and the connecting members 2 to be co-injected onto the first tube member 1, which further reduces the processing difficulty.

In some embodiments, knurling is provided on the outer wall of the second tube member 15.

By providing knurling on the outer wall of the second tube member 15, the slip-resistance of the second tube member 15 can be improved.

The present disclosure also provides a flexible shaft 200.

As shown in FIG. 1, the flexible shaft 200 according to an embodiment of the present disclosure includes the tube assembly described in the foregoing embodiments and a core shaft 10.

The core shaft 10 is disposed in the first tube member 1, and both ends of the core shaft 10 pass through the connecting members 2 provided at both ends of the first tube member 1 and extend into the second tube members 15. One end of the core shaft 10 is connected to a first drive connecting member 11, with the end of the first drive connecting member 11 away from the core shaft 10 extending into the corresponding second tube member 15; the other end of the core shaft 10 is connected to a second drive connecting member 12, with the end of the second drive connecting member 12 away from the core shaft 10 extending into the corresponding housing.

The core shaft 10 can be made of steel wire rope, giving it a certain degree of flexibility to allow bending.

It should be understood that, on one hand, since the connections between the first drive connecting member 11 and the core shaft 10 and between the second drive connecting member 12 and the core shaft 10 are both located within the second tube member 15, the second tube member 15 can protect these connection points, preventing damage to the connection between the first drive connecting member 11 and the core shaft 10 and the connection between the second drive connecting member 12 and the core shaft 10.

On the other hand, by making part of the first drive connecting member 11 and part of the second drive connecting member 12, and configuring the first drive connecting member 11 and the second tube member 15 concentrically, excessive offset of the first drive connecting member 11 during rotation can be avoided. Similarly, by configuring the second drive connecting member 12 and the second tube member 15 concentrically, excessive offset of the second drive connecting member 12 during rotation can be prevented. At the same time, the clearance between the first drive connecting member 11 and the second tube member 15, as well as the clearance between the second drive connecting member 12 and the second tube member 15, should be set within an appropriate range. If it is too large, the anti-offset effect of the second tube member 15 is reduced; if it is too small, excessive friction may occur between the second tube member 15 and the first drive connecting member 11 or the second drive connecting member 12, which can affect transmission.

The flexible shaft 200 according to an embodiment of the present disclosure is capable of transmitting motion between two ends that are not on the same axis. For example, the first drive connecting member 11 can be connected to a screwdriver, and the second drive connecting member 12 can be connected to a screw. The screwdriver can drive the core shaft 10 to rotate, which in turn drives the screw to rotate, enabling screws located in positions that are inconvenient for placing a screwdriver to be installed or removed, thereby improving work efficiency.

In some embodiments, the flexible shaft 200 according to the present disclosure further includes a spring 13, which is sleeved on the outside of the core shaft 10 and disposed between the connecting member 2 and the first drive connecting member 11.

Furthermore, one end of the spring 13 abuts against the connecting member 2, and the other end of the spring 13 abuts against the first drive connecting member 11.

By providing the spring 13 between the connecting member 2 and the first drive connecting member 11, the exposed length of the first drive connecting member 11 can be adjusted by compression, facilitating adaptation to different required lengths.

In some embodiments, the first drive connecting member 11 is an external hexagonal joint, and the second drive connecting member 12 is an internal hexagonal joint.

Optionally, the second drive connecting member 12 may be a quick-release internal hexagonal joint. The quick-release internal hexagonal joint is known in the prior art and will not be described in detail here. Apparently, the types of the first drive connecting member 11 and the second drive connecting member 12 can be selected according to actual transmission requirements.

The above-described embodiments are only intended to illustrate the technical solutions of the present disclosure and are not intended to limit it. Although the present disclosure has been described in detail with reference to the foregoing embodiments, those skilled in the art should understand that modifications can still be made to the technical solutions described in the foregoing embodiments, or certain technical features can be replaced with equivalents. Such modifications or replacements do not cause the essence of the corresponding technical solutions to depart from the spirit and scope of the embodiments of the present disclosure, and should all be included within the protection scope of the present disclosure.

What is claimed is:

1. A tube assembly for a flexible shaft, comprising:
a first tube member, wherein connecting members are provided at both axial ends of the first tube member; and
a second tube member sleeved on an outer peripheral wall of at least one of the two connecting members; wherein
an inner peripheral wall of the second tube member is provided with a first groove extending circumferentially, the outer peripheral wall of the connecting member is provided with a first protrusion extending circumferentially and engaging with the first groove, and
the inner peripheral wall of the second tube member is provided with a second protrusion extending circumferentially, the outer peripheral wall of the connecting member is provided with a second groove extending circumferentially and engaging with the second protrusion.

2. The tube assembly for the flexible shaft of claim 1, wherein the first groove is singular, and the first protrusion is singular.

3. The tube assembly for the flexible shaft of claim 1, wherein the first grooves are plural, and the plurality of first grooves are spaced apart axially along the second tube member; and
the first protrusions are plural, and the plurality of first protrusion are spaced apart axially along the connecting member.

4. The tube assembly for the flexible shaft of claim 1, wherein the second groove is singular, and the second protrusion is singular.

5. The tube assembly for the flexible shaft of claim 1, wherein the second grooves are plural, and the plurality of second groove are spaced apart axially along the connecting member; and
the second protrusion are plural, and the plurality of second protrusion are spaced apart axially along the second tube member.

6. The tube assembly for the flexible shaft of claim 1, wherein the inner peripheral wall of the second tube member is provided with a third groove extending axially, the outer peripheral wall of the connecting member is provided with a third protrusion extending axially and engaging with the third groove, and
the inner peripheral wall of the second tube member is provided with a fourth protrusion extending axially, the outer peripheral wall of the connecting member is provided with a fourth groove extending axially and engaging with the fourth protrusion.

7. The tube assembly for the flexible shaft of claim 2, wherein the inner peripheral wall of the second tube member is provided with a third groove extending axially, the outer peripheral wall of the connecting member is provided with a third protrusion extending axially and engaging with the third groove, and
the inner peripheral wall of the second tube member is provided with a fourth protrusion extending axially, the outer peripheral wall of the connecting member is provided with a fourth groove extending axially and engaging with the fourth protrusion.

8. The tube assembly for the flexible shaft of claim 3, wherein the inner peripheral wall of the second tube member is provided with a third groove extending axially, the outer peripheral wall of the connecting member is provided with a third protrusion extending axially and engaging with the third groove, and
the inner peripheral wall of the second tube member is provided with a fourth protrusion extending axially, the outer peripheral wall of the connecting member is provided with a fourth groove extending axially and engaging with the fourth protrusion.

9. The tube assembly for the flexible shaft of claim 4, wherein the inner peripheral wall of the second tube member is provided with a third groove extending axially, the outer peripheral wall of the connecting member is provided with a third protrusion extending axially and engaging with the third groove, and
the inner peripheral wall of the second tube member is provided with a fourth protrusion extending axially, the outer peripheral wall of the connecting member is provided with a fourth groove extending axially and engaging with the fourth protrusion.

10. The tube assembly for the flexible shaft of claim 5, wherein the inner peripheral wall of the second tube member is provided with a third groove extending axially, the outer peripheral wall of the connecting member is provided with a third protrusion extending axially and engaging with the third groove, and
the inner peripheral wall of the second tube member is provided with a fourth protrusion extending axially, the outer peripheral wall of the connecting member is provided with a fourth groove extending axially and engaging with the fourth protrusion.

11. The tube assembly for the flexible shaft of claim 6, wherein the third groove is singular, and the third protrusion is singular.

12. The tube assembly for the flexible shaft of claim 6, wherein the third grooves are plural, and the plurality of third grooves are spaced apart circumferentially along the inner peripheral wall of the second tube member; and the third protrusions are plural, and
the plurality of third protrusions are spaced apart circumferentially along the outer peripheral wall of the connecting member.

13. The tube assembly for the flexible shaft of claim 6, wherein the fourth groove is singular, and the fourth protrusion is singular.

14. The tube assembly for the flexible shaft of claim 6, wherein the fourth grooves are plural, and the plurality of fourth groove are spaced apart circumferentially along the outer peripheral wall of the connecting member; and
the fourth protrusion are plural, and the plurality of fourth protrusion are spaced apart circumferentially along the inner peripheral wall of the second tube member.

15. The tube assembly for the flexible shaft of claim 1, wherein a hose is sleeved on an outer wall of the first tube member.

16. The tube assembly for the flexible shaft of claim 1, wherein knurling is provided on an outer wall of the second tube member.

17. A flexible shaft, comprising:
the tube assembly for the flexible shaft of claim 1, and a core shaft, wherein
the core shaft is provided in the first tube member, two ends of the core shaft pass through the connecting members provided at both ends of the first tube member and extend into the second tube member;
an end of the core shaft is connected to a first drive connecting member, an end of the first drive connecting member away from the core shaft extends out of the corresponding second tube member; and
another end of the core shaft is connected to a second drive connecting member, an end of the second drive connecting member away from the core shaft extends out of the corresponding second tube member.

18. The flexible shaft of claim 17, further comprising a spring, wherein the spring is sleeved on the outside of the core shaft and is disposed between the connecting member and the first drive connecting member.
